(19) United States
(12) Patent Application Publication
(10) Pub. No.: US 2013/0013244 A1
(43) Pub. Date: Jan. 10, 2013

(54) PATTERN BASED TEST PRIORITIZATION USING WEIGHT FACTORS

(75) Inventors: William J. Kristiansen, Duvall, WA (US); Richard L. Plotke, Seattle, WA (US)

(73) Assignee: Microsoft Corporation, Redmond, WA (US)

(21) Appl. No.: 13/179,240

(22) Filed: Jul. 8, 2011

(51) Int. Cl. G06F 19/00

(52) U.S. Cl. 702/108

(57) ABSTRACT

Various embodiments provide a pattern-based test prioritization system. Individual patterns are defined and are assigned a weight. The patterns represent the relative importance of particular test variation states. A collection of potential test variations is evaluated against the patterns, and a prioritized test variation order is produced. This prioritized test variation order can then be processed to ascertain a subset of prioritized test variations to undergo testing.

### BACKGROUND

Performing testing in systems that include a large number of potential test variations can be very challenging, particularly when the number of potential test variations grows to be quite large, due to a high-dimension test model. In addition, in many systems, some test variations can be more relevant or germane than other test variations. As such, poorly prioritized test variations can significantly slow down test passes and delay discovery of relevant failures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a pattern-based test prioritization system. Individual patterns are defined and are assigned a weight. The patterns represent the relative importance of particular test variation states. A collection of potential test variations is evaluated against the patterns, and a prioritized test variation order is produced. This prioritized test variation order can then be processed to ascertain a subset of prioritized test variations to undergo testing.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates an example pattern-based testing module, in accordance with one or more embodiments.

FIG. 3 illustrates example test variations in accordance with one example.

FIG. 4 illustrates an example prioritized test variation order in accordance with the FIG. 3 example.

FIG. 5 is a flow diagram that describes steps in a method in accordance with one or more embodiments.

FIG. 6 illustrates an example system that can be utilized to implement one or more embodiments.

### DETAILED DESCRIPTION

Overview

Various embodiments provide a pattern-based test prioritization system. Individual patterns are defined and are assigned a weight. The patterns represent the relative importance of particular test variation states. A collection of potential test variations is evaluated against the patterns, and a prioritized test variation order is produced. This prioritized test variation order can then be processed to ascertain a subset of prioritized test variations to undergo testing.

Accordingly, testing efficiencies are gained insofar as being able to identify and test more germane test variations earlier in the testing process and, in some instances, eliminating less or non-relevant test variations.

In the discussion that follows, a section entitled “Operating Environment” is provided and describes one environment in which one or more embodiments can be employed. Following this, a section entitled “Example Pattern-Based Testing Module” describes an example pattern-based testing module in accordance with one or more embodiments. Next, a section entitled “Example Test” describes an example test that illustrates aspects of the illustrated and described embodiments. Following this, section entitled “Example Method” describes an example method in accordance with one or more embodiments. Next, a section entitled “Example Implementation Scenarios” describes various scenarios in which the inventive embodiments can be employed. Last, a section entitled “Example System” describes an example system that can be utilized to implement one or more embodiments.

Consider now an example operating environment in which one or more embodiments can be implemented.

Operating Environment

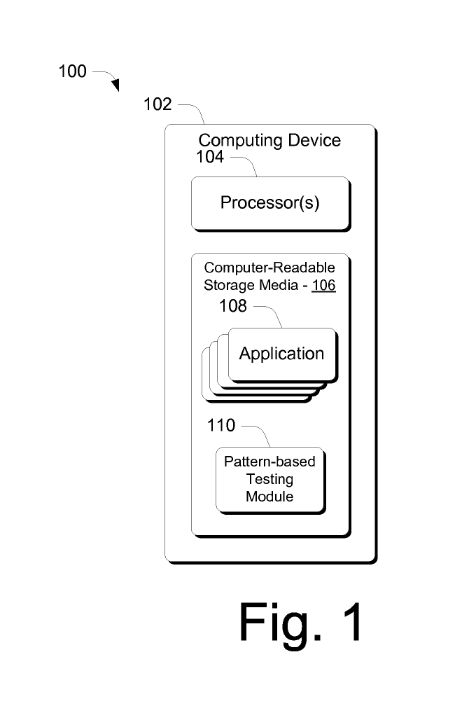

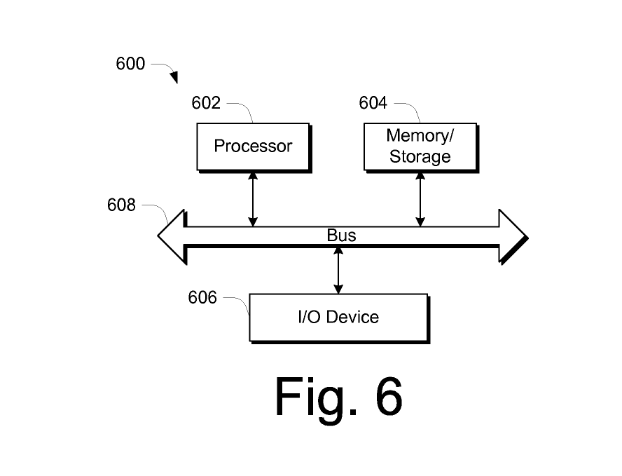

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 6.

In addition, computing device 102 includes a software module in the form of a pattern-based testing module 110. The pattern-based testing module is configured to define one or more patterns and assign weights to the individual patterns. The patterns represent the relative importance of particular test variation states. A collection of potential test variations is evaluated, by the pattern-based testing module, against the patterns, and a prioritized test variation order is produced. This prioritized test variation order can then be processed to ascertain a subset of prioritized test variations to undergo actual testing. The pattern-based testing module can be utilized in a wide variety of testing environments, as will become apparent below.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of functionality associated with pattern-based testing module 110.

Example Pattern-Based Testing Module

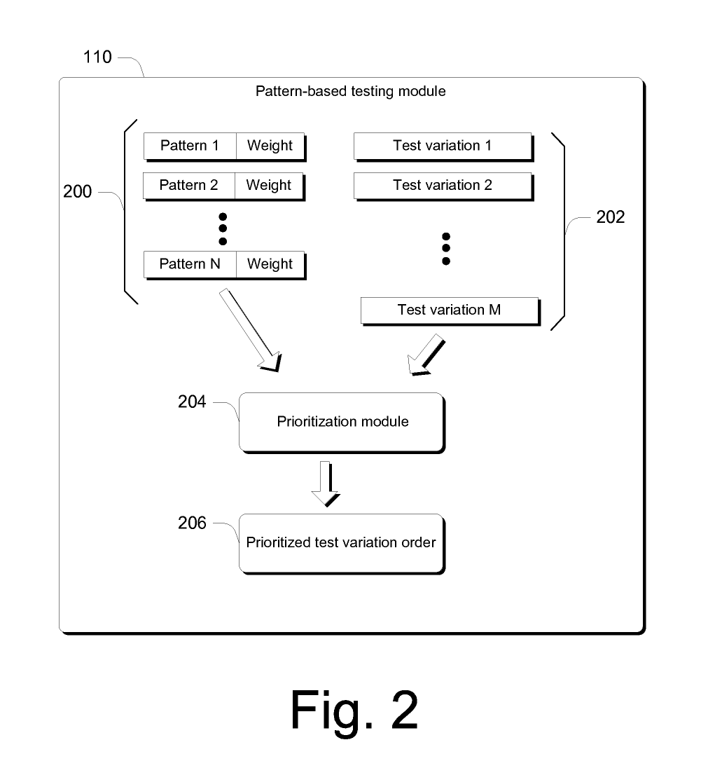

FIG. 2 illustrates an example pattern-based testing module 110, in accordance with one or more embodiments. In this particular example, the pattern-based testing module includes a collection of patterns 200 each of which is assigned a weight, a collection of test variations 202, a prioritization module 204, and a prioritized test variation order 206.

Patterns within the collection of patterns 200 constitute aspects of a description of a test variation and an associated numeric weight, for the variation, that represents the relative importance of test variations 202 that match this particular pattern. A test variation represents a specific state of a collection of parameters or dimensions used within a particular test process. An example of specific test variations is provided below.

In operation, the prioritization module 204 evaluates individual test variations of the test variation collection 202 in terms of whether the variation matches one or more patterns. If no matches are found for a particular test variation, a pre-defined weight can be assigned to the non-matching variation. If, on the other hand, a test variation matches one or more patterns, it is assigned a weight in accordance with its match. For example, if a test variation matches one pattern, then this variation is assigned the weight associated with the matching pattern. If, on the other hand, a test variation matches more than one pattern, it is assigned a mathematical combination of the weights of the associated patterns.

The prioritization module 204 then sorts the weighted test variations to produce a prioritized test variation order 206. The prioritized test variation order can then be used as a basis to select actual test variations to undergo testing, or to run a test in a particular defined order. By virtue of providing a prioritized test variation order, costs associated with automated testing can be reduced while, at the same time, problem identification can be performed more efficiently due to the reduced number of actually-tested test variations. One way to do this is to run the highest priority test variations early and possibly with higher frequency than lower protest variations.

For example, in a particular testing scenario there may be tens of thousands of test variations, each of which represents a unique state of a particular test. The tester may want to set a particular state, run the test in the particular state, and verify that the test is correct or incorrect in that state. Because of the number of variations, it becomes very difficult to select which variations are most important. However, utilizing the approach described above and below, relevant higher-priority test variations can be identified quickly and earlier in the process to facilitate efficient testing.

In the examples described above and below, patterns can be defined to have any particular suitable type of form. For example, patterns can be defined mathematically and can be as complex as the test designer wishes. Alternately or additionally, patterns can be defined using, for example, regular expressions, formulaic approaches, Boolean relationships, scenario matching, logical sets or relationships, text strings, and the like.

Having considered an example pattern-based testing module, consider now an example test that illustrates, in a simplified manner, the power of the pattern-based testing module.

Example Test

As noted above, when managing a large number of automated test variations it can be desirable to keep testing costs as low as possible, while efficiently going about finding problems before, for example, a particular product is released to a customer. One way to do this is to run the highest priority test variations early and possibly with higher frequency than lower priority test variations. The solution described just below quantifies test variation priorities using combinations of patterns.

In the example that follows, given a set of weighted patterns, properties of each test variation are compared against each pattern. All weight factors of patterns that match the test variation are mathematically combined, e.g., multiplied together, to become the “Priority Value” of that test variation. After Priority Values are computed for a set of test variations, those variations can be sorted or indexed based on the priority value. From here, efficient testing decisions can be made as to which test variations are to undergo actual testing and/or how selected test variations are to be tested.

For purposes of this example, assume that the following data will be referenced as an example of all possible test case variations for a hypothetical test using meal combinations. Parameters are Entrée, Beverage, and Side. Assume the following parameters and value sets for the individual parameters:

Entrée
Eggs
Burger
Pizza
Side
Fries
Salad
Sausage
Beverage
Milk
Soda
Water

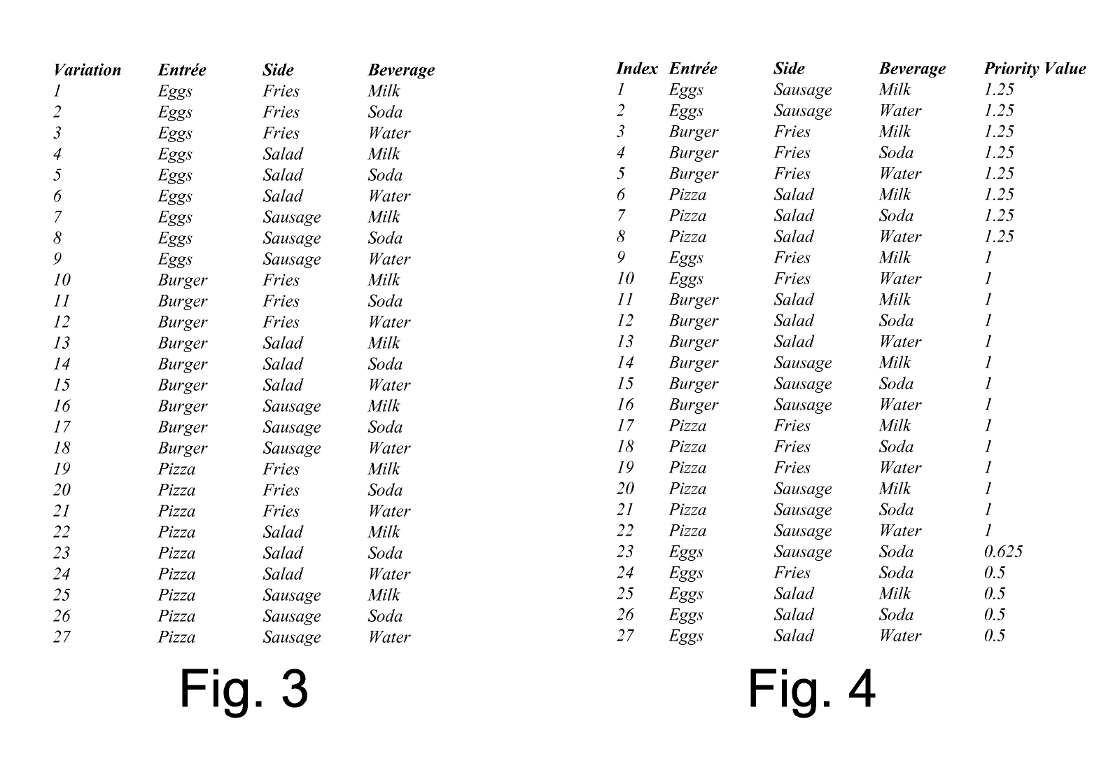

Assuming these parameters and value sets are combined using all possible combinations, then there are 27 total variations. As an example, consider FIG. 3 which illustrates the test variations. In this particular example, assume that variation 5 (eggs, salad, soda) is of relatively low importance, yet appears near the start of a list. Assume also that variation 23 is of relatively high importance, yet appears near the end of the list. Were this collection of variations to be tested as it appears in FIG. 3, then more important test variations would be tested later than the process, thus leading to inefficiencies.

Assume now that a tester defines the following priority patterns and assigns the patterns the indicated weights:

| Pattern | Weight |
|---|---|
| Entrée = Eggs AND Side = Sausage | 1.25 |
| Entrée = Burgers AND Side = Fries | 1.25 |
| Entrée = Pizza AND Side = Salad | 1.25 |
| Entrée = Eggs AND (Side = Salad OR Beverage = Soda) | 0.5 |

Using these patterns and weights, each of the individual test variations appearing in FIG. 3 can be tested in terms of whether they match a particular pattern or patterns. If a test variation matches one or more patterns, it can be assigned an appropriate priority value. For example, if a test variation matches one pattern, its priority value would be the corresponding weight of the pattern that it matched. If a test variation matches more than one pattern, its priority value would be a mathematical combination of the weights of the corresponding patterns that it matched.

Using the above-defined patterns and applying them in an evaluation of the test variations that appear in FIG. 3, the resulting prioritized test variation order is shown in FIG. 4.

Notice in the FIG. 4 example that test variations that are more important, such as the test variation appearing at index 7 (formerly variation 23 in FIG. 3) is higher in the list, than test variations that are of lesser importance such as the test variation appearing at index 26 (formerly variation 5 in FIG. 3).

Having described an example test to illustrate the power of the pattern-based testing module, consider now a discussion of an example method in accordance with one or more embodiments.

Example Method

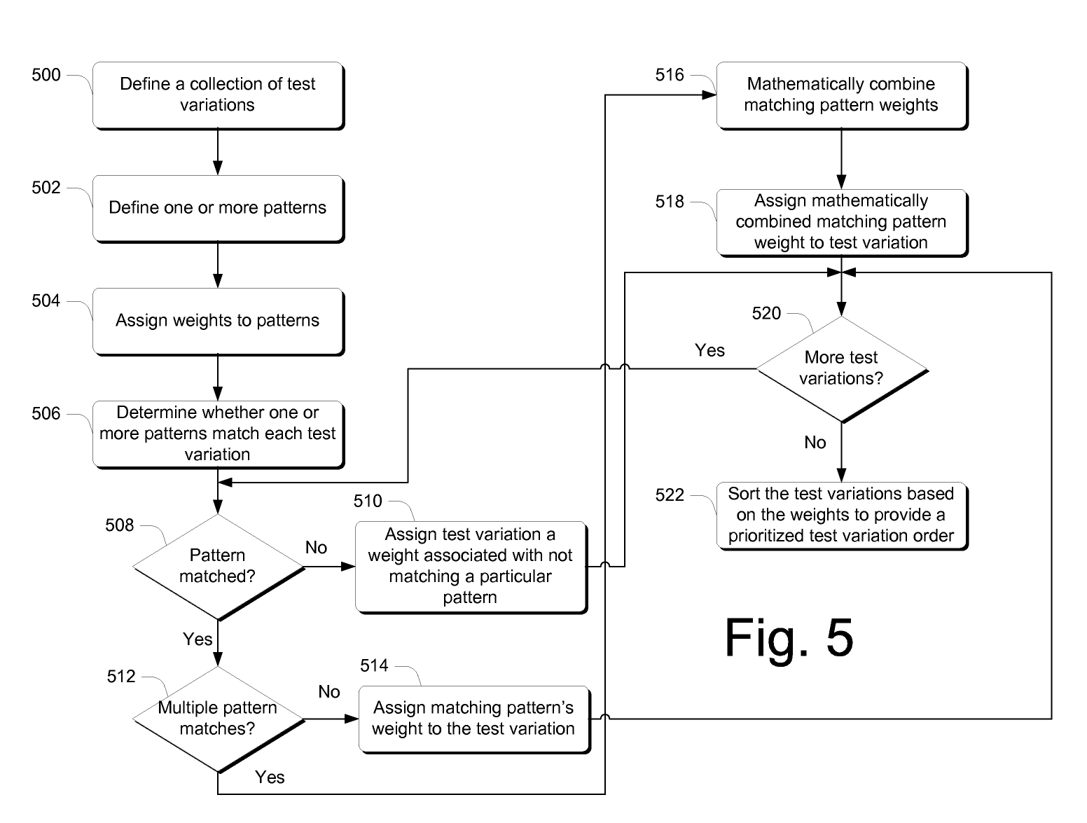

FIG. 5 is a flow diagram that describes an example method in accordance with one or more embodiments. The method can be performed in connection with any suitable hardware, software, firmware or combination thereof In at least some embodiments, the method can be performed by a suitably-configured software module, such as pattern-based testing module 110.

Step 500 defines a collection of test variations. This step can be performed in any suitable way. For example, a suitably configured user interface can enable the collection of test variations to be defined. Any suitable type of test variations can be defined. In the embodiments described above, the test variations include multiple parameters individual ones of which can have different value sets. Step 502 defines one or more patterns. The patterns can be defined in any suitable way. In one or more embodiments, patterns can be enabled to be defined based on input received, via a user interface, from a tester, such as a human tester. Step 504 assigns weights to the patterns defined in step 502. This step can be performed in any suitable way. In accordance with the discussion above, weights can be determined for patterns based on the relative importance of the individual parameter values that appear in any particular pattern. Then, through a suitably configured user interface, the weights can be assigned to the patterns. Step 506 determines whether one or more patterns match each test variation.

If, at step 508, no patterns match the particular test variation, step 510 assigns the test variation a weight associated with not matching a particular pattern. The method can then branch to step 520 to ascertain whether more test variations exist to be tested. If, on the other hand, step 508 ascertains that a pattern matches a particular test variation, step 512 ascertains whether multiple patterns match a particular test variation. If not, then step 514 assigns the matching pattern's weight to the test variation and the method branches to step 520 to ascertain whether more testing is to be conducted. If, on the other hand, step 512 ascertains that multiple patterns match a particular test variation, step 516 mathematically combines the matching pattern weights, and step 518 assigns the mathematically combined matching pattern weights to the particular test variation. The weights of matching patterns can be mathematically combined in a suitable way. In one or more embodiments, weights of matching patterns can be combined by taking their product.

Step 520 determines whether more test variations remain to be tested. If so, the method returns to step 508 for the next test variation. If all the test variations have been tested and none remain to be tested, step 522 sorts the test variations based on the weights to provide a prioritized test variation order. An example of a prioritized test variation order is provided above.

The prioritized test variation order can now form the basis by which additional test-related decisions can be made. For example, a subset of a prioritized test variation order might be selected for actual testing. Alternately or additionally, higher frequency testing may occur on those test variations that appear near the top of the prioritized test variation order list.

Having described an example method in accordance with one or more embodiments, consider now a discussion of example implementation scenarios in accordance with one or more embodiments.

Example Implementation Scenarios

The techniques discussed above have applicability in a wide variety of testing scenarios. For example, the techniques can be employed in software testing scenarios where different feature sets of particular software are tested. For example, consider testing in the software graphics space. For particular software graphics programs, various texture feature sets or formats can be tested in terms of their operation in connection with graphics hardware. Specifically, there may be dozens of different formats that a particular texture might be able to use, but for any given scenario, there may be a small set number of formats that are actually employed. Given whatever test is being performed relative to the different formats, patterns can be defined and utilized to develop a smaller number of test variations to undergo actual testing.

As another example in the graphics space, consider the following. Game customers tend to use textures that are a power of two in width and height. This is because it can be more efficient to use these particularly-dimensioned textures when working with certain graphics hardware. Thus, higher weights might be assigned to patterns that include values associated powers of two, rather than those patterns that do not include values associated with powers of two.

Other software-related testing scenarios can include those scenarios in which APIs are tested. Specifically, often times APIs have validation code that is utilized to check whether parameters that are passed into a method are valid. From one aspect of testing, when functional testing is being performed, the tester wants to ascertain that valid values are passed in, and that the method performs as it is supposed to. Thus, in the context of API testing, more important test variations may be those in which parameters are passed in. Thus, patterns having values associated with parameters that are passed into a particular API may be weighted higher than those patterns that do not have values associated with parameters that are passed in.

As will be appreciated by the skilled artisan, the above-described techniques can be employed in scenarios other than software testing. For example, the testing techniques can be applied in the context of implementing processes and switching variations within a manual process by priority, manually testing or measuring dimensional aspects of a product or system, product assembly, inventory control, and any other particular area in which a number of test variations exist which are desired to be tested.

Example System

FIG. 6 illustrates an example computing device 600 that can be used to implement the various embodiments described above. Computing device 600 can be, for example, computing device 102 of FIG. 1 or any other suitable computing device.

Computing device 600 includes one or more processors or processing units 602, one or more memory and/or storage components 604, one or more input/output (I/O) devices 606, and a bus 608 that allows the various components and devices to communicate with one another. Bus 608 represents one or more of any of several types of bus structures, including a memory bus or memory controller, a peripheral bus, an accelerated graphics port, and a processor or local bus using any of a variety of bus architectures. Bus 608 can include wired and/or wireless buses.

Memory/storage component 604 represents one or more computer storage media. Component 604 can include volatile media (such as random access memory (RAM)) and/or nonvolatile media (such as read only memory (ROM), Flash memory, optical disks, magnetic disks, and so forth). Component 604 can include fixed media (e.g., RAM, ROM, a fixed hard drive, etc.) as well as removable media (e.g., a Flash memory drive, a removable hard drive, an optical disk, and so forth).

One or more input/output devices 606 allow a user to enter commands and information to computing device 600, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide a pattern-based test prioritization system. Individual patterns are defined and are assigned a weight. The patterns represent the relative importance of particular test variation states. A collection of potential test variations is evaluated against the patterns, and a prioritized test variation order is produced. This prioritized test variation order can then be processed to ascertain a subset of prioritized test variations to undergo testing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

1. A computer-implemented method comprising:
determining whether one or more patterns match individual test variations;
for test variations that do not match any patterns, assigning non-matching test variations a weight associated with not matching any patterns;
for test variations that match one or more patterns, assigning matching test variations a weight associated with matching one or more patterns; and
sorting weighted test variations to provide a prioritized test variation order that is to be used in a testing process.

2. The computer-implemented method of claim 1, wherein said assigning matching test variations a weight associated with one or more patterns comprises:
mathematically combining two or more weights for a test variation that matches, respectively, two or more patterns; and
assigning a mathematically combined weight to the test variation that matches the two or more patterns.

3. The computer-implemented method of claim 2, wherein mathematically combining comprises taking a product of the two or more weights.

4. The computer-implemented method of claim 1, wherein individual patterns of the one or more patterns have an associated weight that is usable to conduct acts of assigning.

5. The computer-implemented method of claim 1, wherein the one or more patterns are defined as regular expressions.

6. The computer-implemented method of claim 1, wherein the one more patterns are defined as Boolean relationships.

7. The computer-implemented method of claim 1, wherein the one or more patterns are defined as text strings.

8. The computer-implemented method of claim 1, wherein the test variations pertain to software testing.

9. The computer-implemented method of claim 1, wherein the test variations pertain to graphics software testing.

10. The computer-implemented method of claim 1, wherein the test variations pertain to scenarios other than software testing.

11. One or more computer readable storage media embodying instructions which, when executed, implement a system comprising:
a pattern-based testing module configured to utilize a collection of patterns to numerically prioritize test variations, each pattern being assigned a weight, individual patterns of the collection of patterns describing aspects of a test variation,
the pattern-based testing module being further configured to assign pattern weights to individual test variations that match one or more patterns and sort weighted test variations to provide a prioritized test variation order.

12. The one or more computer readable storage media of claim 11, wherein the pattern-based testing module is configured to mathematically combine pattern weights associated multiple patterns that match a particular test variation, and assign the mathematically combined pattern weights to the particular test variation.

13. The one or more computer readable storage media of claim 12, wherein the pattern-based testing module is configured to mathematically combine the pattern weights by taking a product of the pattern weights.

14. The one or more computer readable storage media of claim 11, wherein the patterns are defined as regular expressions.

15. The one or more computer readable storage media of claim 11, wherein the patterns are defined as Boolean relationships.

16. The one or more computer readable storage media of claim 11, wherein the patterns are defined as text strings.

17. The one or more computer readable storage media of claim 11, wherein individual test variations represent a specific state of a collection of parameters that are used within a test process.

18. One or more computer readable storage media embodying instructions which, when executed, implement a method comprising:
enabling a collection of test variations to be defined, the test variations pertaining to software testing;
enabling one or more patterns to be defined;
enabling weights to be assigned to individual patterns;
determining whether one or more patterns match individual test variations;
for test variations that do not match any patterns, assigning non-matching test variations a weight associated with not matching any patterns;
for test variations that match one or more patterns, assigning matching test variations a weight associated with matching one or more patterns; and
sorting weighted test variations to provide a prioritized test variation order that is to be used in a software testing process.

19. The one or more computer readable storage media of claim 18, wherein said assigning matching test variations a weight associated with one or more patterns comprises:
mathematically combining two or more weights for a test variation that matches, respectively, two or more patterns; and
assigning a mathematically combined weight to the test variation that matches the two or more patterns.

20. The one or more computer readable storage media of claim 18, wherein the one or more patterns are defined as regular expressions.
